(19) United States
(12) Patent Application Publication
(10) Pub. No.: US 2025/0232076 A1
(43) Pub. Date: Jul. 17, 2025

(54) Aircraft Testing Using Measurement Data and Predictive Data

(71) Applicant: The Boeing Company, Arlington, VA (US)

(72) Inventors: Noah Eric Aaron, Edmonds, WA (US); Kevin Joseph Hougen, Seattle, WA (US); Paul Murray, Huntsville, AL (US); Philip Weldon Groves, Seattle, WA (US); Bryan Douglas Welsh, Seattle, WA (US); Vito Joseph Malta, II, Edgewood, WA (US)

(21) Appl. No.: 18/410,004

(22) Filed: Jan. 11, 2024

(51) Int. Cl. G06F 30/15

(52) U.S. Cl. CPC G06F 30/15

(57) ABSTRACT

Systems and methods of evaluating aircraft behavior. The systems and methods perform simulated testing using computer-based models to determine predicted behavior of the aircraft. The systems and methods further use measurement data collected during operation of a test aircraft to determine actual behavior of the aircraft. The systems and methods provide for comparing the predicted and actual behaviors to provide for more accurate analysis of the aircraft. In some examples, the systems and methods provide for live flight test optimization which eliminates and/or reduces the need for extraneous flight testing.

### TECHNOLOGICAL FIELD

The present disclosure relates generally to the field of aircraft testing and, more specifically, to testing using measurement data that is sensed during an aircraft operation and predictive data using one or more digital models.

### BACKGROUND

Aircraft are tested at one or more times during their life cycle. For aircraft, the testing is often performed during the design phase prior to full production. The testing includes one or more test programs and certification campaigns to ensure aircraft safety and performance. The testing provides a structural assessment of a variety of aspects including but not limited to wing flexibility, aileron operation, fuselage pressure testing, and fatigue tests encountered during take-off and landing.

Some aircraft testing is performed using a computer simulation that is a computer-based process that uses one or more digital models of the aircraft. The testing allows for analyzing the aircraft in use and exposed to a wide variety of different situations and environments. The simulations determine predicted performance of the aircraft when exposed to the various situations and environments.

Other testing uses a test aircraft that is constructed according to the aircraft specifications. Sensors are positioned about the aircraft to detect one or more aspects. The test aircraft provides actual performance data which can be accessed on a real-time basis. A disadvantage is the cost involved in building a test aircraft.

Current systems do not provide a meaningful way to use both computer simulation testing and test aircraft testing. The testing is done using one test process or the other.

### SUMMARY

One aspect is directed to a method of analyzing an aircraft design. The method comprises: obtaining measurement data detected during operation of a test aircraft with the test aircraft constructed in accordance with the aircraft design; obtaining predictive data that is based on digital simulation models that represent the aircraft design; comparing the measurement data and the predictive data; generating one or more differences between the measurement data and the predictive data; and displaying the measurement data, the predictive data, and the one or more differences through a graphical user interface.

In another aspect, the measurement data comprises physical characteristics that occur during operation of the test aircraft and the predictive data comprises expected physical characteristics that are expected to occur during operation of the test aircraft.

In another aspect, the method further comprises determining the one or more differences between the measurement data and the predictive data in real time during the operation of the test aircraft.

In another aspect, the method further comprises: determining when the measurement data is sensed by one or more sensors; applying a timestamp to the measurement data; receiving the measurement data with the timestamp; generating the predictive data using the measurement data and the timestamp; and synchronizing the predictive data and the measurement data.

In another aspect, the method further comprises receiving the measurement data from sensors that are mounted on the test aircraft.

In another aspect, the method further comprises calculating extrapolated predictive data of expected physical characteristics based on the digital simulation models with the extrapolated predictive data being the physical characteristics that are not sensed by the sensors during the operation of the test aircraft.

In another aspect, the method further comprises determining the one or more differences between the measurement data and the predictive data during ground tests of the test aircraft and during flight tests of the test aircraft.

In another aspect, the method further comprises determining a modification to the aircraft design based on the one or more differences between the measurement data and the predictive data.

In another aspect, the method further comprises updating the digital simulation models based on the one or more differences between the measurement data and the predictive data.

One aspect is directed to a method of analyzing an aircraft design. The method comprises: receiving measurement data from a test aircraft wherein the measurement data is captured by one or more sensors on the test aircraft and indicates an actual performance of the test aircraft; calculating predictive data indicating an expected performance of the aircraft design wherein the predictive data is calculated based on one or more digital simulation models representing the aircraft design; determining one or more differences between the measurement data captured by the one or more sensors and the predictive data based on a comparison of the measurement data to the predictive data; and generating one or more output parameters based on the comparison wherein each of the one or more output parameters indicates a corresponding difference between the measurement data and the predictive data.

In another aspect, the method further comprises determining a modification of the aircraft design by inputting the one or more output parameters into a design modification function for the aircraft design.

In another aspect, the method further comprises calculating extrapolated predictive data of expected physical characteristics based on the digital simulation models with the extrapolated predictive data being the physical characteristics that are not sensed by the sensors during the operation of the test aircraft.

In another aspect, the method further comprises determining the one or more differences between the measurement data and the predictive data in real time during operation of the test aircraft.

In another aspect, the method further comprises updating the digital simulation models based on the one or more differences between the measurement data and the predictive data.

In another aspect, the method further comprises receiving measurement data from the test aircraft during ground tests of the test aircraft and during flight tests of the test aircraft.

In another aspect, the method further comprises synchronizing the measurement data and the predictive data using a timestamp that is applied to the measurement data.

One aspect is directed to a system to analyze an aircraft design. The system comprises sensors mounted on a test aircraft and configured to detect one or more physical characteristics during operation of a test aircraft. A computing device comprises processing circuitry and memory circuitry comprising a program 58 that when executed by the processing circuitry, cause the computing device to: receive measurement data from the sensors of the one or more physical characteristics detected during operation of the test aircraft; calculate predictive data based on digital simulation models that represent the aircraft design; determine one or more differences between the measurement data and the predictive data; and based on the one or more differences, update the system.

In another aspect, the update to the system comprises determining one or more modifications to the aircraft design.

In another aspect, the processing circuitry is configured to determine extrapolated predictive data of expected physical characteristics that are not sensed by the sensors during the operation of the test aircraft.

In another aspect, a display is configured to receive signals from the processing circuitry and display the measurement data, the predictive data, and the one or more differences on a display through a graphical user interface.

The features, functions and advantages that have been discussed can be achieved independently in various aspects or may be combined in yet other aspects, further details of which can be seen with reference to the following description and the drawings.

### BRIEF DESCRIPTION OF THE DRAWINGS

FIG. 1 is a schematic diagram of a system having actual test data and predictive simulation data.

FIG. 2 is a schematic diagram of a system for storing and processing measurement data and predictive data.

FIG. 3 is a schematic diagram of running a simulation using one or more digital models.

FIG. 4 is a flowchart diagram of a method of comparing measurement data and predictive data.

FIG. 5 is a flowchart diagram of a method of updating a system based on determined differences between measurement data and predictive data.

FIG. 6 is a flowchart diagram of a method of utilizing digital models to generate extrapolated predictive data.

FIG. 7 is a graphical user interface having a display of differences between measurement data and predictive data.

FIG. 8 is a flowchart diagram of a method of monitoring the timing of the data processing.

FIG. 9 is a schematic diagram of a computing device.

FIG. 10 is a schematic diagram of a simulation server.

### DETAILED DESCRIPTION

The present application is directed to systems and methods of evaluating aircraft behavior. The systems and methods perform simulated testing using computer-based models to determine predicted behavior of the aircraft. The systems and methods further use measurement data collected during operation of a test aircraft to determine actual behavior of the aircraft. The systems and methods provide for comparing the predicted and actual behaviors to provide for more accurate analysis of the aircraft design. In some examples, the systems and methods provide for live flight test optimization which eliminates and/or reduces the need for extraneous flight testing.

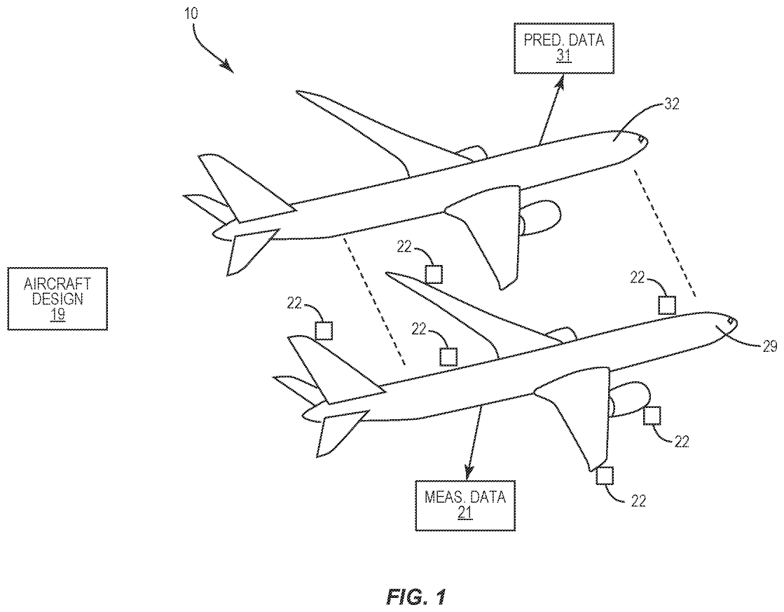

FIG. 1 schematically illustrates the functionality of the systems and methods of analyzing an aircraft design 19. The aircraft design 19 includes the engineering specifications for the aircraft. One or more test aircraft 29 are manufactured based on the aircraft design 19. In addition, one or more digital models 32 are created that represent a virtual test aircraft. The systems 10 and methods test the aircraft design 19 based on measurement data 21 obtained from the test aircraft 29 and predictive data 31 obtained from the digital models 32.

Actual measurement data 21 is obtained from tests that are performed using the test aircraft 29. Sensors 22 on the test aircraft 29 sense physical characteristics that are experienced during the operation of the test aircraft 20. Various types of sensors 22 are used to collect the measurement data 21. Examples of sensors 22 include but are not limited to piezoelectric, capacitive, and piezoresistive flexible bending sensors, vibration sensors, force sensors, tachometers, engine temperature sensors, fuel gauges, pressure sensors, altimeter, airspeed sensor, gyroscopic sensors, flow sensors, position sensors, moments of inertia, aircraft gross weight, flight test air data, flight test airplane inertial data, and accelerometers.

The predictive data 31 is obtained running simulations using the one or more digital models 32. The digital models 32 are composed of equations that define the functional relationships between the various components in the aircraft design 19. The digital models 32 cover areas and/or functions of the aircraft. When the simulations are run, the mathematical dynamics form an analog of the behavior of the aircraft with the results presented in the predictive data 31. The predictive data 31 is the physical characteristics that are expected to occur during operation of an aircraft that is built according to the aircraft design 19. In some examples, the predictive data 31 can be output as a graphical image that represents the dynamic processes in a static or dynamic sequence.

The analysis identifies differences between the predictive data 31 of digital models 32 and the measurement data 21 obtained from the sensors 22. The differences can be indicative of one or more issues, such as but not limited to issues with the aircraft design 19, digital models 32, sensors 22, and the testing protocols.

In some examples, the test aircraft 29 and the digital models 32 are full versions of the aircraft. In some examples, the test aircraft 29 can fly and many of the tests are performed during flight tests. In other examples, one or both of the test aircraft 29 and the digital models 32 are one or more limited sections of the aircraft. For example, the test aircraft 29 is just a landing gear assembly or just a wing of the aircraft. Likewise, the digital models 32 can represent the entire aircraft, or just one or more smaller sections of the aircraft such as just the landing gear assembly.

The measurement data 21 and predictive data 31 include a variety of physical characteristics of the aircraft that occur during operation. Examples include but are not limited to bending of the wing, fuselage pressure, landing gear tire pressure, wheel temperatures, brake temperatures, brake energy, stresses on the tail assembly, airplane coefficients (Cl, Cd, Cy, Cr, Cm, Cn), predicted surface positions, brake torque, and predicted parameters that are not monitored by the flight test data.

Testing of the test aircraft 29 can occur under various conditions and environments. Testing can include one or more of ground tests and flight tests. In some examples, the analysis of the measurement data 21 and the predictive data 31 occurs on a real-time basis. This provides for the results of the comparisons and other analysis to be completed while the tests are still being performed. In one specific example, this occurs during a test flight. Changes as a result of the comparisons of the data 21, 31 can be made while the test aircraft 29 is still operating. Previous systems have a delay in returning the predictive data 31 and therefore require an additional test flight or other use of the test aircraft 29 which can be time-consuming and expensive. Another advantage of the real-time results is the same testing conditions are available for subsequent testing thus providing for more accurate results (as opposed to conducting a subsequent test at a different time in which one or more conditions may be different).

In some examples, changes are made to one or more aspects of the system 10 as a result of determining differences between the data 21, 31. In some examples, the changes include updating the digital models 32 in view of differences with the actual performance data. The updated models 32 provide more accurate predictive data 31 during future testing. Accurate digital models 32 can also provide for calculating extrapolated predictive data 31 that does not have corresponding measurement data 21. For example, measurement data 21 can include an amount of bend in the wing and an amount of force applied to the wing during the bending. Predictive data 31 can be calculated using the digital models 32 to determine a movement of a flight control member (e.g., aileron) at the time the wing is bent.

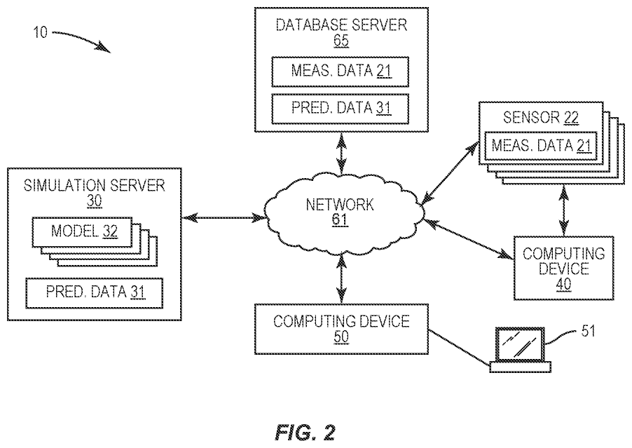

FIG. 2 is a functional block diagram illustrating the architecture of an exemplary system 10 for testing the aircraft design 19 using measurement data 21 and predictive data 31. As illustrated in FIG. 2, the system 10 comprises one or more IP networks 61 communicatively interconnecting sensors 22, computing devices 40, 50, database server 65, and simulation server 30. The IP network 61 is a communication network that comprises multiple computers and other devices (e.g., routers, gateway nodes, and the like). The computers and devices in the IP network 61 are configured to use the Internet Protocol (IP) to send and receive data packets between endpoints such as the simulation server 30, and computing devices 40, 50. Generally, IP networks and their operations are well-known to those of ordinary skill in the art; however, it should be appreciated that the IP network 61 seen in FIG. 2 may comprise one or more public networks (e.g., the Internet) and/or private networks.

The database server 65 is a computer or similar device that uses a database application to store and maintain the measurement data 21 and predictive data 31. The database server 65 includes memory circuitry configured to contain programming instructions that are used by processing circuitry to maintain the data 21, 31. The database server 65 is configured to retain the measurement data time stamps so that the predictive data 31 will be output and time stamped with the measurement data time stamps. This provides a clear indication of a predictive data lag compared with the measurement data 21. In some examples, the display device 51 is configured to align the data time stamps of the measurement data 21 which is showing the aircraft state at ‘now’ with the predictive data time stamps which depending on the complexity of the model may be slightly lagged from ‘now’ but will be available and accurate to when the aircraft was being measured. In some examples, if the one or more models 32 are taking significantly too long to calculate a predictive result the user will know this by observing that the predictive data is no longer available in the near real-time window of the graphical user interface (GUI). The measurement data 21 can be received as raw data from the sensors 22 and/or received from the computing device 40 that processes the raw data prior to sending to the database server 65.

The simulation server 30 is a computer or similar device configured to maintain the digital models 32. In operation, the simulation server 30 receives the measurement data 21 from the database server 65 via the IP network 61, and based on that data, executes the simulations during the testing to obtain the predictive data 31. The simulation server 30 then outputs the predictive data 31 via the IP network 61 to the database server 65 to be stored.

The computing device 50 is configured to obtain the measurement data 21 and the predictive data 31 from the database server 65 via the IP network 61 and perform the analysis to identify the differences between the predictive data 31 and the measurement data 21. In some examples, the results are output to a display 51 that is operatively connected to the computing device 50. For example, the output can be displayed on a graphical user interface (GUI) displayed on display 51. According to the present embodiments, the GUI can include one or more graphical components (e.g., icons, menus, and the like) configured to provide a user with the capability to interact with the GUI to convey needed information to the user.

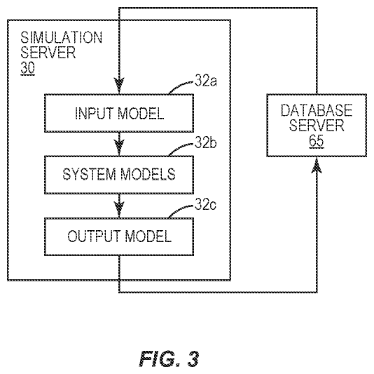

FIG. 3 illustrates a schematic representation of the processing performed by the simulation server 30 according to some examples. As previously stated, the simulation server 30 obtains data from the database server 65 and performs the simulations to generate the predictive data 31. As seen in FIG. 3, the data models 32 upon which the simulations are executed comprise an input model 32a, one or more system models 32b, and an output model 32c. In some examples, the input model 32a is configured to receive the measurement data 21 from the database server 65. In some examples, the measurement data 21 is received from the database server 65 and appropriately formatted for direct use during the simulations. In some examples, the input model 32a is configured to map the data from the database server 65 for use by the simulation server 32.

One or more system models 32b are used to perform one or more simulations to generate the predictive data 31. As stated above, the predictive data 31 comprises values representing the predicted behavior of or outcome of operation of the aircraft. The one or more digital models 32b represent varying portions and functions of the aircraft. Each system model 32b is configured to organize data related to the operation of the aircraft, and further, standardizes how that data relates to other data. In some examples, the one or more digital models 32b comprise data representing the functions of the entirety of the aircraft. In other examples, the one or more digital models 32b comprise data representing one or more limited sections or functions of the aircraft. Examples of such limited sections or functions include but are not limited to the fuselage, wings, cockpit, engine, tail assembly, and landing gear.

An output model 32c outputs the predictive data 31 to the database server 65. In some examples, the output model 32c includes a mapping function that formats the predictive data 31 output by the system models 32b according to a format of the database server 65. As stated above, the database server 65 receives the predictive data 31 from the simulation server 30 and stores the predictive data 31 in memory.

The computing device 50 is configured to obtain and perform calculations using the measurement data 21 and the predictive data 31. FIG. 4 illustrates a method 109 performed by the computing device 50 of comparing the data 21, 31. The method includes obtaining the measurement data 21 that was measured during operation of the test aircraft 29 (block 100). The method also includes obtaining the predictive data 31 that is based on the digital models 32 that represent the aircraft design (block 102). The computing device 50 compares the measurement data and the predictive data (block 104). One or more differences are determined between the measurement data 21 and the predictive data 31 (block 106). The information is displayed on the display device 51 (block 108).

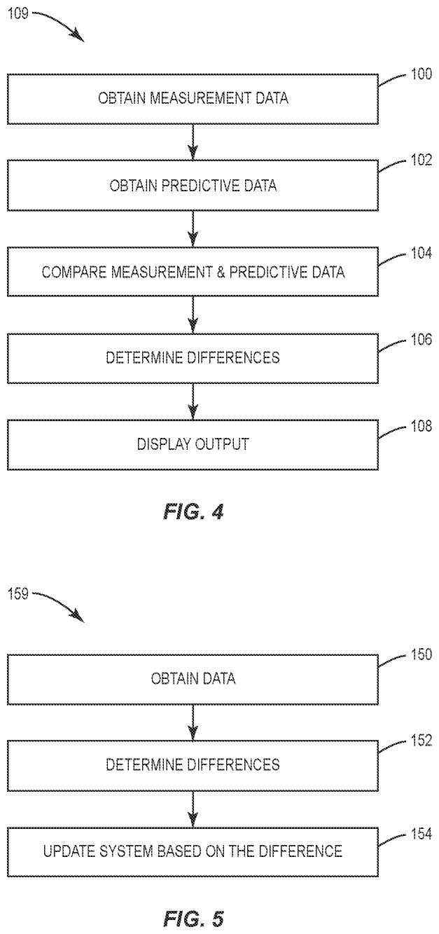

In some examples, one or more aspects of the system 10 are updated as a result of the determined differences between the measurement data 21 and the predictive data 31. FIG. 5 illustrates a method 159 of making changes to the system 10. The method includes obtaining the measurement data 21 and the predictive data 31 (block 150). Differences are determined between the measurement data 21 and the predictive data 31 (block 152). Based on the differences, updates are made to one or more aspects of the system 10 (block 154).

In some examples, the changes are made when the differences exceed a predetermined amount such as a predetermined percentage difference between the data 21, 31. The changes can be made to one or more of the components of the system 10. In some examples, changes are made to the aircraft design 19 as the expected and actual operation indicate an issue. In one specific example, the predictive data 31 indicated a certain bending on the wings under predetermined circumstances but the measurement data 21 indicates a larger amount of bending. Additionally or alternatively, one or more of the digital models 32 are updated to more accurately conform to the outcome detected by the actual measurement data 21. Additionally or alternatively, one or more of the sensors 22 are determined to be at issue and are replaced.

The system 10 provides for the digital models 32 to provide for accurate predictive data 31 indicative of the behavior of the aircraft. In some examples, the digital models 32 also provide for extrapolating to determine behavior that does not have corresponding measurement data 21. For example, the measurement data 21 includes sensed data indicating a tire pressure of one or more tires in the landing gear during operation of test aircraft 29. This measurement data 21 can be compared to corresponding predictive data 31. When the comparison is accurate such that the differences do not exceed a threshold, the indication is the digital models 32 accurately predict the behavior of the aircraft. The digital models 32 can then be used to determine additional aspects about the behavior that are not detected by sensors 22 on the test aircraft 29.

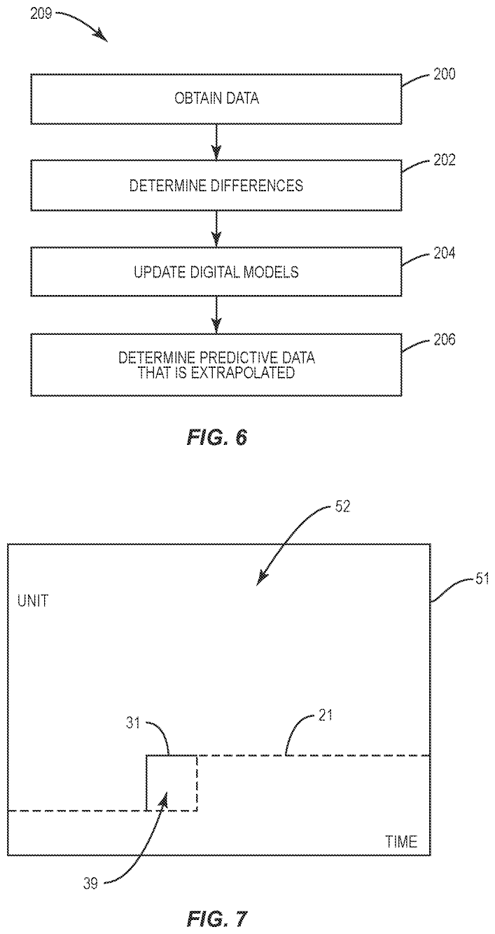

FIG. 6 illustrates a method 209 of determining extrapolated predictive data 31. Measured data 21 and predictive data 31 are obtained (block 200) and differences are determined (block 202). The one or more digital models 32 are updated based on the differences (block 204). In some examples, the digital models 32 are updated when the differences exceed a predetermined amount. The process can continue for various cycles until the digital models 32 provide accurate predictive behavior indicated by the differences between the data 21, 31 being below the predetermined threshold. After the digital models 32 are determined to be accurate, one or more of the digital models 32 are used to calculate extrapolated predictive data 31 that is not sensed by the sensors 22 (block 206).

The output of the calculations performed by the computing device 50 can have various formats. Examples include data tables, graphs, charts, and dynamic models. In some examples, the output is displayed on the display device 51. FIG. 7 includes the display device 51 configured to display a GUI 52. The GUI 52 displayed on the display device 51 is configured to display a variety of information and data from which an operator can better comprehend the data 21, 31, as well as the comparisons between the measurement data 21 and the predictive data 31. For example, the network operator uses the GUI 52 to select an image and/or modify the image. FIG. 7 illustrates an example of a GUI 52 that displays the measurement data 21 and the predictive data 31 in a manner that highlights the differences 39 between the two. In some examples, the GUI 52 highlights the one or more differences 39.

The system 10 is configured to process the data 21, 31 in a timely manner. In some examples, the data 21, 31 is processed in real time such that a test aircraft 29 or simulation that is operational can be used for additional testing if necessary.

In some examples, the system 10 ensures that the predictive data 31 is time aligned to when the measurement data 21 was sensed. The system 10 has time stamping of when a sensor 22 senses the signal. The measurement data 21 and the timestamp are passed to the simulation sever 30 that runs simulations and computes the predictive data 31. The system 10 is configured to monitor the difference in time between when the measurement data 21 is sensed by the sensor 22 and when the corresponding predictive data 31 is calculated. The predictive data 31 is calculated using the timestamp. This provides for synchronizing the measured data 21 and the predictive data 31 in time. The synchronization provides for observing what the simulation generates at a given time provided the same conditions that the test aircraft encountered at that time. A lag between when the measurement data 21 is sensed and when the simulation generates the predictive data 31 is determined. If the lag exceeds a predetermined amount, the system 10 indicates an error message that can be sent to a remote node and/or displayed on the display 51.

In some examples, the lag is determined by the simulation server 30 after calculating the predictive data 31. Additionally or alternatively, the lag is determined by the database server 65 at the time the predictive data 31 is sent from the simulation server 30.

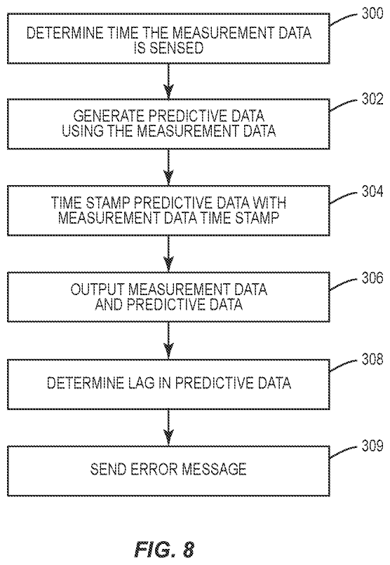

In some examples, the analysis of the data 21, 31 is performed in real time. Real time includes the actual time during which the testing of the test aircraft 29 and/or the running of the simulations occurs. FIG. 8 illustrates a method of monitoring the timing of the data processing. The method includes determining the time at which the measurement data 21 is sensed by the sensor 22 (block 300). In some examples, the data is time stamped by the sensor 22. In other examples, the data is time stamped by a computing device 40 or the database server 65. The measurement data 21 is sent to the simulation server 30 which then generates the predictive data 31 (block 302). In some examples, the measurement data 21 is sent directly from the sensor 22 or computing device 40 to the simulation server 30. In other examples, the measurement data 21 is initially sent to the database server 65 and then obtained by the simulation server 30. The predictive data 31 is time stamped with the measurement data time stamp (block 304).

The measurement data 21 and the predictive data 31 is output to a user (block 306). The output can include various manners including but not limited to display on the display device 51 and various graphs and charts. In some examples, the output includes the data 21, 31 aligned using the time stamps which emphasizes the existence of a lag in the generation of the predictive data 31 (block 308). When a lag is determined in the predictive data 31, an error message is generated and sent to one or more nodes (block 309). The lag threshold can vary, with examples including but not limited to 1 second and 10 seconds. In some examples, the data 21, 31 is still valuable even with a lag exceeding the threshold because the data can be analyzed after the condition has been concluded.

FIG. 2 illustrates the system 10 having a distributed architecture in which different components perform different processes. In other examples, one or more of the components can perform multiple functions. For example, a single computing device processes the raw sensor data and also performs the comparison calculations using the measurement data 21 and the predictive data 31. In another example, the simulation server 30 and the database server 65 are incorporated into a single component. In one specific example, the system 10 includes a computing device that receives the measurement data 21 and performs each of the processes and stores the measurement data 21 and predictive data 31.

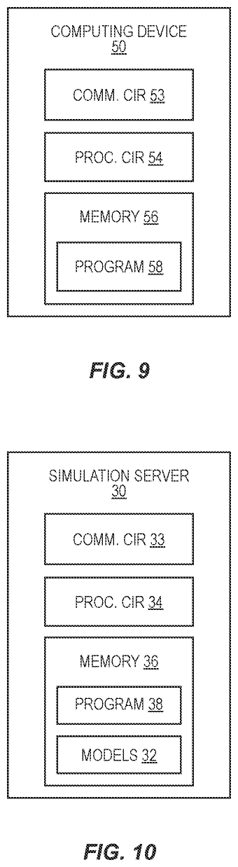

A schematic diagram of the computing device 50 is illustrated in FIG. 9. The computing device 50 comprises communication circuitry 53, processing circuitry 54, and memory 56 configured to store a computer program 58 thereon. The communication circuitry 53 comprises the hardware required for communicating with one or more of the components in the system 10. In this regard, the communication circuitry 53 may comprise a Network Interface Circuit (NIC) (e.g., an ETHERNET or similar interface). In some embodiments, the computing device 50 may be configured for wireless communications. In these situations, communication circuitry 53 would comprise the radio frequency (RF) circuitry needed for transmitting and receiving signals over a wireless communication channel. Accordingly, the computing device 50 may also be coupled to one or more antennae (not shown). In other embodiments, however, computing device 50 is configured to communicate via a wire interface.

The processing circuitry 54 comprises one or more microprocessors, hardware, firmware, or a combination thereof that controls the overall operation of the computing device 50. In accordance with the present disclosure, the processing circuitry 54 can be configured by software to perform one or more of the methods herein described including any of methods 109, 159, 209 seen in FIGS. 4, 5, and 6 respectively and the various other calculations disclosed herein.

Memory 56 comprises both volatile and non-volatile memory for storing computer program code and data needed by the processing circuitry 54 for operation. Memory 56 may comprise any tangible, non-transitory computer-readable storage medium for storing data including electronic, magnetic, optical, electromagnetic, or semiconductor data storage. Memory 56 stores a computer program 58 comprising executable instructions that configure the processing circuitry 54 to perform one or more of the methods herein described. A computer program 58 in this regard may comprise one or more code modules corresponding to the means or units described above. Additionally, according to the present disclosure, the computer program 58 may comprise the instructions and data for one or both database server 65 and simulation server 30.

Regardless, computer program instructions and configuration information are stored in a non-volatile memory, such as a ROM, erasable programmable read only memory (EPROM) or flash memory. Temporary data generated during operation may be stored in a volatile memory, such as a random-access memory (RAM). In some embodiments, computer program 58 for configuring the processing circuitry 54 as herein described may be stored in a removable memory, such as a portable compact disc, portable digital video disc, or other removable media. The computer program 58 may also be embodied in a carrier such as an electronic signal, optical signal, radio signal, or computer readable storage medium.

Those skilled in the art will also appreciate that embodiments herein further include corresponding computer programs. A computer program comprises instructions which, when executed on at least one processor of an apparatus, cause the apparatus to carry out any of the respective processing described above. A computer program in this regard may comprise one or more code modules corresponding to the means or units described above.

Embodiments of the present disclosure further include a carrier containing such a computer program 58. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by the computing device 50. This computer program product may be stored on a computer readable recording medium.

In certain embodiments, some or all of the functionality described herein may be provided by processing circuitry 54 executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry 54 alone or to other components of the computing device 50, but are enjoyed by the computing device 50 as a whole, and/or by end users and a wireless network generally.

Computing device 50, simulation server 30, and database server 65 are configured to further process the data in the methods disclosed above. These components include corresponding communication circuitry 53, processing circuitry 54, and memory 56 to process the data and perform the methods. One or more computer programs are stored in memory that provide instructions for processing circuitry of the component to perform the functions herein disclosed.

The simulation server 30 is configured to process the measurement data 21 using the digital models 32 and output the corresponding predictive data 31. FIG. 10 schematically illustrates an example of the simulation server 30 that comprises communication circuitry 33, processing circuitry 34, and memory 36 configured to store the models 32 of a computer program 38 thereon. The communication circuitry 33 comprises the hardware required for communicating with one or more of the components in the system 10. The communication circuitry 33 is configured to provide for one or more of wireless communications or via a wire interface. The processing circuitry 34 comprises one or more microprocessors, hardware, firmware, or a combination thereof that controls the overall operation of the simulation server 30. In accordance with the present disclosure, the processing circuitry 34 can be configured by software to perform one or more of the methods herein.

Memory 36 comprises both volatile and non-volatile memory for storing computer program code and data needed by the processing circuitry 34 for operation. Memory 36 may comprise any tangible, non-transitory computer-readable storage medium for storing data including electronic, magnetic, optical, electromagnetic, or semiconductor data storage. Memory 36 stores the computer program 38 comprising executable instructions that configure the processing circuitry 34 to perform one or more of the methods herein described.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A method of analyzing an aircraft design, the method comprising:
obtaining measurement data detected during operation of a test aircraft with the test aircraft constructed in accordance with the aircraft design;
obtaining predictive data that is based on digital simulation models that represent the aircraft design;
comparing the measurement data and the predictive data;
generating one or more differences between the measurement data and the predictive data; and
displaying the measurement data, the predictive data, and the one or more differences through a graphical user interface.

2. The method of claim 1, wherein the measurement data comprises physical characteristics that occur during operation of the test aircraft and the predictive data comprises expected physical characteristics that are expected to occur during operation of the test aircraft.

3. The method of claim 1, further comprising determining the one or more differences between the measurement data and the predictive data in real time during the operation of the test aircraft.

4. The method of claim 1, further comprising:
determining when the measurement data is sensed by one or more sensors;
applying a timestamp to the measurement data;
receiving the measurement data with the timestamp;
generating the predictive data using the measurement data and the timestamp; and synchronizing the predictive data and the measurement data.

5. The method of claim 1, further comprising receiving the measurement data from sensors that are mounted on the test aircraft.

6. The method of claim 5, further comprising calculating extrapolated predictive data of expected physical characteristics based on the digital simulation models with the extrapolated predictive data being the physical characteristics that are not sensed by the sensors during the operation of the test aircraft.

7. The method of claim 1, further comprising determining the one or more differences between the measurement data and the predictive data during ground tests of the test aircraft and during flight tests of the test aircraft.

8. The method of claim 1, further comprising determining a modification to the aircraft design based on the one or more differences between the measurement data and the predictive data.

9. The method of claim 1, further comprising updating the digital simulation models based on the one or more differences between the measurement data and the predictive data.

10. A method of analyzing an aircraft design, the method comprising:
receiving measurement data from a test aircraft, wherein the measurement data is captured by one or more sensors on the test aircraft and indicates an actual performance of the test aircraft;
calculating predictive data indicating an expected performance of the aircraft design, wherein the predictive data is calculated based on one or more digital simulation models representing the aircraft design;
determining one or more differences between the measurement data captured by the one or more sensors and the predictive data based on a comparison of the measurement data to the predictive data; and
generating one or more output parameters based on the comparison, wherein each of the one or more output parameters indicates a corresponding difference between the measurement data and the predictive data.

11. The method of claim 10, further comprising determining a modification of the aircraft design by inputting the one or more output parameters into a design modification function for the aircraft design.

12. The method of claim 10, further comprising calculating extrapolated predictive data of expected physical characteristics based on the digital simulation models with the extrapolated predictive data being the physical characteristics that are not sensed by the sensors during operation of the test aircraft.

13. The method of claim 11, further comprising determining the one or more differences between the measurement data and the predictive data in real time during operation of the test aircraft.

14. The method of claim 11, further comprising updating the digital simulation models based on the one or more differences between the measurement data and the predictive data.

15. The method of claim 11, further comprising receiving measurement data from the test aircraft during ground tests of the test aircraft and during flight tests of the test aircraft.

16. The method of claim 11, further comprising synchronizing the measurement data and the predictive data using a timestamp that is applied to the measurement data.

17. A system to analyze an aircraft design, the system comprising:
sensors mounted on a test aircraft and configured to detect one or more physical characteristics during operation of a test aircraft;
a computing device comprising:
processing circuitry; and
memory circuitry comprising a program that, when executed by the processing circuitry, cause the computing device to:
receive measurement data from the sensors of the one or more physical characteristics detected during operation of the test aircraft;
calculate predictive data based on digital simulation models that represent the aircraft design;
determine one or more differences between the measurement data and the predictive data; and
based on the one or more differences, update the system.

18. The system of claim 17, wherein the update to the system comprises determining one or more modifications to the aircraft design.

19. The system of claim 17, wherein the processing circuitry is configured to determine extrapolated predictive data of expected physical characteristics that are not sensed by the sensors during the operation of the test aircraft.

20. The system of claim 17, further comprising a display configured to receive signals from the processing circuitry and display the measurement data, the predictive data, and the one or more differences on a display through a graphical user interface.
